(19) United States
(12) Patent Application Publication
(10) Pub. No.: US 2022/0239178 A1
(43) Pub. Date: Jul. 28, 2022

(54) BRUSHLESS ELECTRIC MOTOR WITH BUSBAR UNIT

(71) Applicant: NIDEC Motors & Actuators (Germany) GmbH, Bietigheim-Bissingen (DE)

(72) Inventors: Kosuke OGAWA, Stuttgart (DE); Tomoyuki UMEDA, Stuttgart (DE); Farhad KHOSRAVI, Ludwigsburg (DE)

(21) Appl. No.: 17/585,081

(22) Filed: Jan. 26, 2022

(30) Foreign Application Priority Data
Jan. 26, 2021 (DE) 102021101695.9

(51) Int. Cl. H02K 3/50; H02K 3/28; H01R 25/16; H02K 3/52

(52) U.S. Cl. CPC H02K 3/50; H02K 3/522; H01R 25/168; H02K 3/28

(57) ABSTRACT

A brushless electric motor includes a rotor rotatable about an axis of rotation, a stator that surrounds the rotor externally and includes a stator core and coils wound on the stator core, and a busbar assembly including a busbar holder surrounding first busbars. The windings are made of a winding wire including a first end portion on one side and a second end portion on another side of the winding wire. The first busbars are electrically contacted with the second end portions, the busbar holder being placed on a top of the stator, and the busbar holder includes fastening arms which engage in longitudinal grooves of the stator.

### CROSS REFERENCE TO RELATED APPLICATION

The present application claims priority under 35 U.S.C. §119 to German Application No. 10 2021 101 695.9, filed on Jan. 26, 2021 the entire contents of which are hereby incorporated herein by reference.

### 1. Field of the Invention

The present disclosure relates to a brushless electric motor, and to a method of mounting a busbar assembly.

### 2. Background

A brushless electric motor as a three-phase electric machine has a stator with a number of stator teeth arranged, for example, in a star shape, which carry an electric stator winding in the form of individual stator coils which are in turn wound from an insulating wire. The coils are assigned to individual strands with their coil ends and are interconnected in a predetermined manner via common connecting conductors. In the case of a brushless electric motor as a three-phase AC machine, the stator has three strands and thus at least three connecting conductors to which electric current is applied in a phase-shifted manner in each case in order to generate a rotating magnetic field in which a rotor or armature, usually provided with permanent magnets, rotates. The connecting conductors are fed to motor electronics to control the electric motor. The coils of the stator winding are interconnected in a certain way by the connecting conductors. The type of interconnection is determined by the winding scheme of the stator winding, whereby a star connection or a delta connection of the coils is usual as a winding scheme.

Conventionally, the connecting conductors are designed in the form of busbars which are manufactured as stamped and bent parts from a copper material. For this purpose, the busbars including a number of hook- and/or plug-tongue-shaped contact elements are stamped out of a corresponding sheet material and the busbar thus formed is bent in a ring shape.

In a three-phase motor, there may be three first busbars to which end portions on one side of the winding wires of the three coil groups are respectively connected, each including an external connection terminal, a second busbar for a neutral point to which end portions on the other side of the winding wires of the three coil groups are connected, and a resin holder holding the three first busbars and the second busbar. All components are combined in one busbar assembly.

### SUMMARY

Example embodiments of the present disclosure provide brushless electric motors each including a busbar assembly which is simple to make and has a low axial height.

Accord to an example embodiment of the present invention, a brushless electric motor including a rotor rotatably supported about an axis of rotation and a stator externally surrounding the rotor and including a stator core and coils wound on the stator core is provided. The windings are each made of a winding wire including a first end portion on one side and a second end portion on another side of the winding wire. The electric motor further includes a busbar assembly with first bus bars and a bus bar holder surrounding the first bus bars. The first bus bars are electrically contacted with the second end portions, the bus bar holder is placed on top of the stator, and the bus bar holder includes mounting arms that engage longitudinal grooves of the stator.

This allows a connection defined in the axial direction to be made between the busbar assembly and the stator. Since the busbar assembly rests on the top of the stator and the connection is made below it by the longitudinal slots, the busbar assembly builds up only slightly in the axial direction.

The axis of rotation of the rotor coincides with the longitudinal axis of the stator. When speaking of a radial direction or circumferential direction, reference is always made to the longitudinal axis of the stator or axis of rotation of the rotor. The upper side of the stator is the side on which the winding wire ends protrude.

The busbar support is preferably manufactured by injection molding, with the busbars being at least partially overmolded.

Preferably, the busbar holder includes an annular base body from which the fastening arms project radially outwards, the fastening arms being angled in the direction of the stator and engaging with their ends in a respective longitudinal groove of the stator.

In order to define the axial position precisely, the fastening arms preferably include lugs at their free ends which are received in the longitudinal grooves of the stator and thus form an axial limit for insertion.

In an advantageous example embodiment, each of the first busbars includes a power source connection terminal adapted to be electrically connected to a power source, the power source connection terminals are held in a holding portion of the busbar holder which is radially outward, outside the base body of the busbar holder.

The retaining section is thus formed in one piece during the manufacture of the busbar holder, thus reducing the number of parts.

Preferably, a fastening arm is also provided on the retaining section.

It may further be provided that the busbar assembly includes second busbars grounding the outer, first end portions. These second busbars preferably each extend in the circumferential direction over an angular range including three successive coils of different phases, so that the three first end portions of these coils are in contact with a common second busbar.

To define stator teeth, the stator can include insulators partially surrounding the stator core, on which the windings are arranged and on which the second busbars of the busbar assembly are placed at the end surfaces. Preferably, the second busbars contact the first end portions via contact elements which extend radially inwards from the main busbar.

It is advantageous if the second busbars are provided separately from the busbar support and occupy an imaginary circle whose inner circumference is larger than the outer circumference of the busbar support. The axial height of the arrangement can thus be further reduced.

Further provided is a method of mounting a bus bar assembly on a stator, the stator including a stator core and coils wound on the stator core, the windings being formed from a winding wire including a first end portion on one side and a second end portion on the other side of the winding wire, the bus bar assembly including first bus bars, a bus bar holder surrounding the first bus bars, and second bus bars, the method including placing the busbar holder on an upper side of the stator, the busbar holder including fastening arms which engage in longitudinal grooves of the stator during placement, and contacting the second end portions with the respective busbar, the second end portions being bent from the inside to the outside in a radial direction with respect to the longitudinal axis of the stator to contact the busbars.

As already described above, this procedure precisely defines the axial position of the busbar support.

The method may further include placing the second busbars on the top of the stator and contacting the second busbars with the first end portions to ground the winding wires before placing the busbar holder on the upper side of the stator.

The first and second busbars are preferably provided at the end portions as described above.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 shows a top view of a stator with a busbar assembly arranged on the end surface.

FIG. 2 shows a detailed view of the busbar assembly of FIG. 1.

FIG. 3 shows a schematic diagram of the mounting of the busbar assembly on the stator.

### DETAILED DESCRIPTION

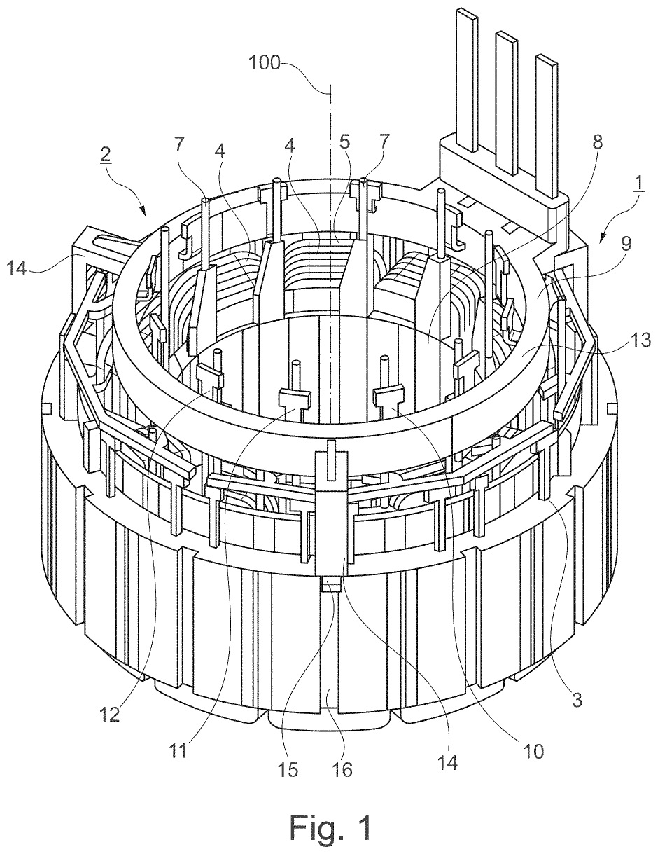

FIG. 1 shows a stator 1 with mounted, essentially annular busbar assembly 2. The stator 1 has a stator core which extends coaxially to a longitudinal axis 100 and has a plurality of stator core segments not shown. Insulators 3 are associated with the stator core segments on the end surfaces. Coils 4 are wound around stator core segments and insulators 3 forming the armatures. The coils 4 each have a winding wire 5 which has a first, not shown, end portion on one side of the winding wire and a second end portion 7 on the other side of the winding wire. The stator is wound in a radial direction from the outside to the inside. By definition, the first end portion is located in the region of the outside of the stator and the second end portion 7 is located in the region of the inside of the stator. The insulators 3 are made of an electrically insulating material to avoid short circuits between winding wires 5 of different phases. The stator core segments may be at least partially made of a ferromagnetic material, such as ferromagnetic steel. The stator 1 is fixedly mounted within a housing of an electric motor and is adapted to generate a time-varying magnetic field by the coils 4. A magnetized rotor, which is not shown, is thereby mounted in the central opening 8 of the stator 1. It is arranged to be rotated by an interaction with the time-varying magnetic field generated by the coils 4. The busbar assembly 2 is arranged to electrically contact the coils 4 of the stator by busbars. The busbar assembly 2 is positioned on an axial side of the stator (top side). The busbar assembly 2 includes a busbar holder 9 and first busbars 10,11,12 held by the busbar holder 9. The first busbars 10,11,12 are made of an electrically conductive material, preferably metal, in particular copper. Each of the first busbars 10,11,12 is formed from a punched strip.

The busbar holder 9 consists at least partly or entirely of an electrically insulating material so that short circuits between the first busbars 10,11,12 can be effectively prevented. The busbar holder 9 is preferably manufactured by injection molding and extends at least partially over the first busbars 10,11,12, which are overmolded. In this way, a fixed and well-defined physical connection can be provided between the busbar holder 9 and the first busbars 10,11,12.

The busbar holder 9 has an annular base body 13 from which two fastening arms 14 extend which project radially outwards from the base body 13 and are angled, the fastening arms 14 extending in the direction of the stator with the angled region when the busbar assembly 2 is mounted on the stator. Each fastening arm 14 has a lug 15 at its free end.

The stator core has packaged stator laminations. The stator core and the stator laminations are grooved on the outside. The slots 16 are longitudinal slots. They extend longitudinally, preferably over the complete height of the stator core, and are evenly spaced along the circumference. The lug 15 of the fastening arms is received, in particular pressed, in one of the longitudinal grooves 16.

This axial connection represents an anti-rotation device. The position of the busbar assembly can thus be clearly defined in the axial and rotational direction.

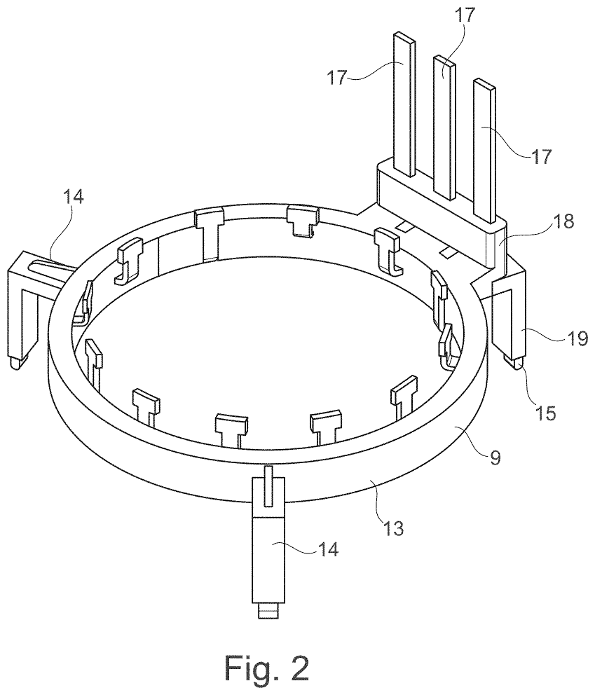

As shown in detail in FIG. 2, each of the first busbars 10,11,12 has a power source connection terminal element 17 adapted to be electrically connected to a power source. The power source connection terminal elements 17 are held in a holding portion 18 of the busbar holder 9. This holding section 18 lies radially outward, outside the base body of the busbar holder 13. The power source connection terminal elements 17 are overmolded during the manufacture of the busbar holder 9 and project with their free ends in the longitudinal direction upward, away from the stator in the assembled state. A further fastening arm 19 is formed on the retaining section 18, which extends downwards in the longitudinal direction, in the assembled state in the direction of the stator, and also engages with an end-side lug 15 in a longitudinal groove of the stator.

The two fastening arms 14 and the third fastening arm 19 are spaced apart from each other in the circumferential direction and have approximately the same distance.

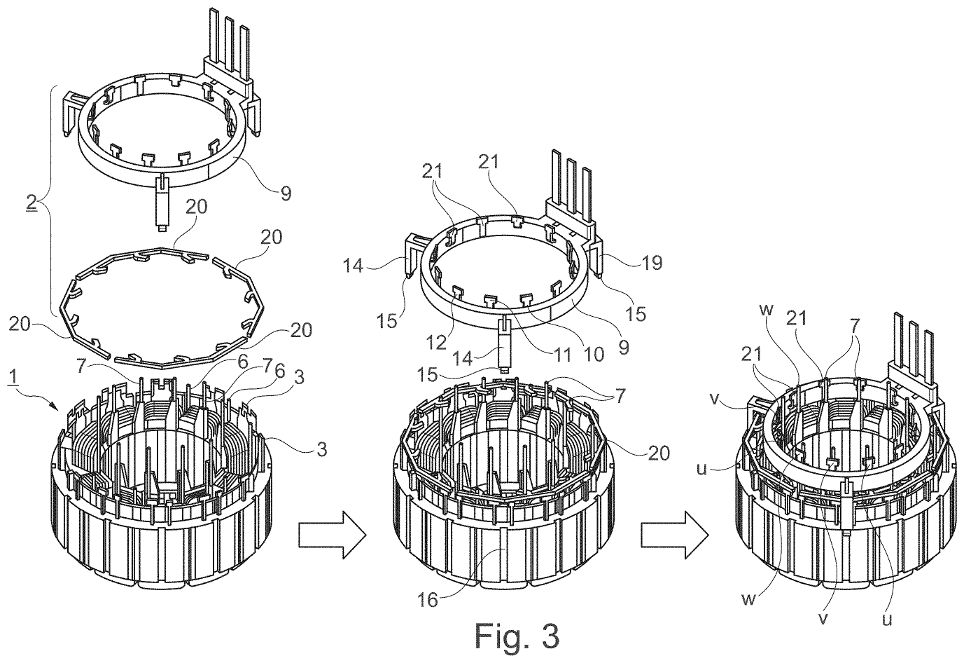

FIG. 3 shows an assembly process in which the busbar assembly 2 is mounted on the stator 1. As can be seen in the first step, on the left, the first end portions 6 and the second end portions 7 of the winding wires 5 are led out of the stator 1 at the end surface. Second busbars 20 of the busbar assembly 2, which are not held in the busbar holder, are placed on the insulators 3 at the end surfaces. The outer, first end portions 6 are contacted with the second busbars, which ground the first end portions 6. The second busbars 20 each extend circumferentially over an angular range comprising three successive coils of different phases, so that the three first end portions 6 of these coils are in contact with a common second busbar 20.

The second busbars 20 form an imaginary circle whose inner circumference is larger than the outer circumference of the busbar holder 9.

After the second busbars 20 have been brought into contact with the insulators 3 and the first end portions of the winding wires 6 have been contacted with them, the busbar holder 9 with the first busbars 10,11,12 is placed on the upper side of the stator 1. In the process, the fastening arms 14,19 engage in the longitudinal grooves 16 on the outside of the stator 1. The lugs of the longitudinal grooves 15 are inserted or pressed into the longitudinal groove 16 from above and limit the insertion depth so that an axial position of the busbar holder 9 relative to the top of the stator is defined.

The busbars 10,11,12 have contact sections 21 which project radially inwards and angled upwards from the busbar holder 9. The contact sections 21 of all busbars are evenly spaced in the circumferential direction. The contact sections 21 project on the inside of the busbar holder 9. The second end portions 7 lie radially inwardly in front of the contact sections 21 and are contacted therewith in a process not shown. Each contact section 21 thus electrically contacts an inner winding wire end. In the circumferential direction, the contact sections are assigned to the phases u,v,w, which are connected four times repeatedly in this order.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A brushless electric motor, comprising:
a rotor mounted to rotate about an axis of rotation;
a stator externally surrounding the rotor and including a stator core and coils wound on the stator core; and
a busbar assembly including a busbar holder surrounding first busbars; wherein
the windings are made from a winding wire including a first end portion on one side of the winding wire and a second end portion on another side of the winding wire;
the first busbars are electrically contacted with the second end portions, the busbar holder is on top of the stator, and the busbar holder includes fastening arms engageable in longitudinal grooves of the stator.

2. The brushless electric motor according to claim 1, wherein the busbar holder includes an annular base body from which the fastening arms project radially outwards, the fastening arms being angled in a direction of the stator and engaging with their ends in respective ones of the longitudinal groove of the stator.

3. The brushless electric motor according to claim 1, wherein the fastening arms include lugs at their free ends which are received in the longitudinal grooves of the stator and define an axial position of the busbar holder relative to the stator.

4. The brushless electric motor according to claim 1, wherein
each of the first busbars includes a power source connection terminal to be electrically connected to a power source; and
the power source connection terminals are held in a holding portion of the busbar holder which is radially outward from the base body of the busbar holder.

5. The brushless electric motor according to claim 4, wherein a fastening arm is provided on the holding portion.

6. The brushless electric motor according to claim 1, wherein the busbar assembly includes second busbars which connect the first end portions to ground.

7. The brushless electric motor according to claim 6, wherein the second busbars each extend circumferentially over an angular range including three successive coils of the windings which correspond to different phases so that three of the first end portions are in contact with a common one of the second busbars.

8. The brushless electric motor according to claim 6, wherein the stator includes insulators partially surrounding the stator core to define stator teeth, the windings being arranged on the insulators, and the second busbars are located at an end surface of the insulators.

9. The brushless electric motor according to claim 6, wherein the second busbars are provided separately from the busbar holder and occupy an imaginary circle, an inner circumference of the imaginary circle being larger than an outer circumference of the busbar holder.

10. A method of mounting a busbar assembly on a stator including a stator core and coils wound on the stator core, the windings being formed from a winding wire including a first end portion on one side and a second end portion on another side of the winding wire, the busbar assembly including first busbars, a busbar holder surrounding the first busbars, and second busbars, the method comprising:
placing busbar holder on an upper side of the stator, the busbar holder including fastening arms which engage in longitudinal grooves of the stator during placement; and
contacting the second end portions with respective ones of the first busbars, the second end portions being bent from an inside to an outside in radial direction to the longitudinal axis of the stator to contact the second end portions with the first busbars.

11. The method according to claim 10, further comprising performing, before the placing of the busbar holder on the upper side of the stator:
placing the second busbars on the upper side of the stator and contacting the second busbars with the first end portions to connect the winding wires to ground.
